(19) United States
(12) Patent Application Publication
(10) Pub. No.: US 2015/0229669 A1
(43) Pub. Date: Aug. 13, 2015

(54) METHOD AND DEVICE FOR DETECTING DISTRIBUTED DENIAL OF SERVICE ATTACK

(71) Applicant: Tencent Technology (Shenzhen) Company Limited, Shenzhen (CN)

(72) Inventors: Xiao XIN, Shenzhen (CN); Xi Chen, Shenzhen (CN)

(73) Assignee: Tencent Technology (Shenzhen) Company Limited, Shenzhen (CN)

(21) Appl. No.: 14/695,654

(22) Filed: Apr. 24, 2015

Related U.S. Application Data
(63) Continuation of application No. PCT/CN2014/083638, filed on Aug. 4, 2014.

(30) Foreign Application Priority Data
Aug. 5, 2013 (CN) 201310337323.5

(51) Int. Cl. H04L 29/06; H04L 12/26; H04L 29/08

(52) U.S. Cl. CPC H04L 63/1458; H04L 67/10; H04L 43/0876; H04L 63/1408

(57) ABSTRACT

A method and device for detecting a DDoS attack are provided. The method includes: acquiring data messages received by a server in a real-time manner, and parsing each of the data messages received by the server within a preset time period to extract a feature from the data message; obtaining a ratio of the number of data messages in each protocol type to a total number of the data messages based on the extracted feature; determining whether the ratio of the number of data messages in each protocol type to the total number of the data messages conforms to the ratio baseline corresponding to the protocol type; and determining that the DDoS attack occurs in the server in a case that the obtained ratio does not conform to the ratio baseline corresponding to the protocol type.

### PRIORITY STATEMENT

This application is a continuation of International Application No. PCT/CN2014/083638, filed on Aug. 4, 2014, which claims priority of Chinese Patent Application No. 201310337323.5, entitled “METHOD AND DEVICE FOR DETECTING DISTRIBUTED DENIAL OF SERVICE ATTACK”, filed with the Chinese Patent Office on Aug. 5, 2013, the disclosures of which are hereby incorporated by reference in their entireties.

### TECHNICAL FIELD

The present disclosure relates to the field of network security technology, and particularly to a method and device for detecting a Distributed Denial of Service (DDoS) attack.

### BACKGROUND

With the rapid development of an internet technology, people use and rely on a network more and more, and network security problems come with it. In particular, network attack incidents (for example, a Distributed Denial of Service attack) for an Internet server happen endlessly, which result in a wide meltdown of a basic operational network. Thus, a security of an important information system suffers a great threat, which seriously endangers economic development, social stability and even national security.

The Distributed Denial of Service (DDoS) attack refers to a denial of service attacker for one or more target servers, which is launched by multiple employed computers respectively. In the DDoS attack, legitimate service requests are utilized to occupy excessive service resources, and therefore the server is unable to process an instruction from a legitimate user. In a Client-Server mode, the attacker may utilize multiple unknowing computers as an attack platform, to multiply a DDoS attack effect. When the server is attacked by high-speed data packets, key resources of the attacked server, such as bandwidth, a buffer zone and CPU resource, are exhausted rapidly. In this case, the attacked server may collapse or spend a lot of time to process the attack of packets, and thus the server cannot work normally, which leads to serious economic loss to the attacked server and the user. Therefore, an important part for constructing a security network is to effectively detect and defend the DDoS attack, which is an important problem to be solved in the field of a network security technology.

In an existing method for detecting the attack, normal traffic of a target server is detected and recorded; and when a difference between a detected traffic and the normal traffic is larger than a threshold, it is considered that the DDoS attack occurs. However, a feature presented by the existing DDoS attack is similar to the feature presented at a peak of the normal network access. In addition, the attacker may fabricate or change randomly a source IP address of a message, and change randomly a content of an attack message, so that it is more difficult to detect the DDoS attack. Therefore, the above detection method only depending on a single detection feature, the method lacks a comprehensive analysis for much traffic or behavioral features. Since a single detection feature is applied, the existing detection method has a poor adaptability to a complex actual application environment. If traffic is increased due to a service newly deployed by the server, a misreport may be arisen, therefore, and thus the existing detection method has a high misreport ratio. In addition, this detection method is difficult to find a DDoS attack without much traffic, such as connection flood and slow HTTP attack.

### SUMMARY

A method and device for detecting a DDoS attack are provided according to the present disclosure, to solve problems that the conventional detection method has a poor adaptability and a high misreport ratio.

A method for detecting a Distributed Denial of Service (DDoS) attack is provided according to an embodiment of the present disclosure. The method includes: acquiring data messages received by a server in a real-time manner, and parsing each of the data messages received by the server within a preset time period to extract a feature from the data message; obtaining a ratio of the number of data messages in each protocol type to a total number of the data messages based on the extracted feature; determining whether the ratio of the number of data messages in each protocol type to a total number of the data messages conforms to a ratio baseline corresponding to the protocol type; and determining that the DDoS attack occurs in the server when the ratio of the number of data messages in each protocol type to a total number of the data messages does not conform to the ratio baseline corresponding to the protocol type.

In addition, a device for detecting a Distributed Denial of Service (DDoS) attack is provided according to an embodiment of the present disclosure. The device includes a parsing module, a ratio obtaining module, a ratio matching module and a determining module. The parsing module is configured to acquire data messages received by a server in a real-time manner, and parse each of the data messages received by the server within a preset time period to extract a feature from the data message. The ratio obtaining module is configured to obtain a ratio of the number of data messages in each protocol type to a total number of the data messages based on the extracted feature. The ratio matching module is configured to determine whether the ratio of the number of data messages in each protocol type to a total number of the data messages conforms to a ratio baseline corresponding to the protocol type. The determining module is configured to determine that the DDoS attack occurs in the server when the ratio of the number of data messages in each protocol type to the total number of the data messages does not conform to the ratio baseline corresponding to the protocol type.

There are the following advantageous effects in the technical solution provided by the embodiments of the present disclosure.

The ratio of the number of data messages in each protocol type to a total number of the data messages is obtained based on the feature extracted from each of the data messages, and in the case that the ratio of the number of data messages in each protocol type to a total number of the data messages does not conform to a ratio baseline, it is determined that the DDoS attack occurs in the server. In this way, the problems that the conventional detection method has a poor adaptability and a high misreport ratio are solved. With the method for detecting the DDoS attack based on the ratio information, the misreport is avoided by determining whether the ratio of the number of data messages in each protocol type to a total number of the data messages conforms to the ratio baseline corresponding to the protocol type, so that it is easy to find the DDoS attack. Therefore, according to the method and device according to the present disclosure, the occurrence of the DDoS attack can be rapidly, accurately, and timely detected, and it is able to adapt to various complex actual environments, for example, an environment in which the DDoS attack does not need too many data messages.

The illustration described above is only an outline of the technical solution of the disclosure, in order to know the technical means of the disclosure clearer, apply the technical means in accordance with content of the specification, and make the described and other objects, features and advantages of the disclosure more obvious and easier to be understood, preferred embodiments are exemplified as follows below in conjunction with accompanying drawings.

### BRIEF DESCRIPTION OF THE DRAWINGS

FIG. 1 is a flow diagram of a method for detecting a Distributed Denial of Service attack according to an embodiment of the present disclosure;

FIG. 2A is a flow diagram of a method for detecting a Distributed Denial of Service attack according to another embodiment of the present disclosure;

FIG. 2B is a graph of a total number of data messages in one day;

FIG. 2C is a graph of a total size of data messages in one day;

FIG. 2D is a graph of a ratio of the number of data messages in one protocol type to a total number of data messages in one day;

FIG. 3 is a flow diagram of a method for detecting a Distributed Denial of Service attack according to yet other embodiment of the present disclosure;

FIG. 4 is a block diagram of a main architecture of a device for detecting a Distributed Denial of Service attack according to an embodiment of the present disclosure;

FIG. 5 is a block diagram of a main architecture of a device for detecting a Distributed Denial of Service attack according to another embodiment of the present disclosure;

FIG. 6 is a block diagram of a main architecture of a device for detecting a Distributed Denial of Service attack according to yet other embodiment of the present disclosure; and

FIG. 7 is a block diagram of a structure of a terminal.

### DETAILED DESCRIPTION

In order to further set out the technical means and effects employed by the disclosure for realizing a preset object of the present disclosure, the method and apparatus for detecting a DDoS attack provided by the present disclosure, specific embodiments, structures and features and effects thereof are illustrated in detail below in conjunction with accompanying drawings and preferred embodiments.

The described and other technical content, characteristics and effects of the disclosure are presented clearly in a detailed description of the preferred embodiments below with reference to the accompanying drawings. The technical means and effects employed by the disclosure for realizing the predetermine object may be known deeply and in detail by the specific embodiments, however, the accompanying drawings are only intended to provide reference and illustration, and not intended to limit the disclosure.

### First Embodiment

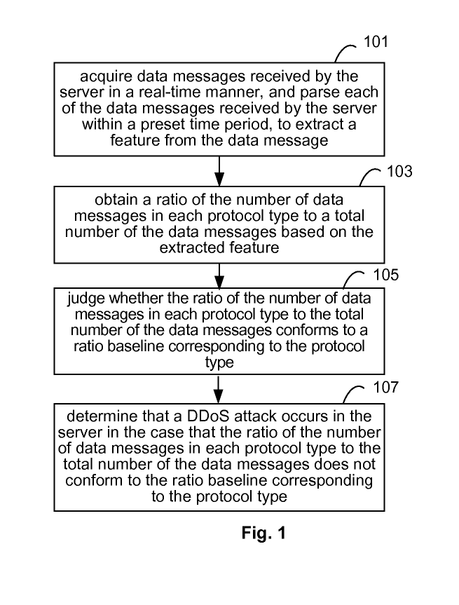

FIG. 1 shows a flow diagram of a method for detecting a Distributed Denial of Service attack according to an embodiment of the present disclosure. The method may be a process of detecting a Distributed Denial of Service attack, which is performed by a device for detecting the Distributed Denial of Service attack. The device for detecting the Distributed Denial of Service attack may run on some apparatus such as a detected server. Taking a case that the device runs on the server as an example, the method for detecting the Distributed Denial of Service attack may include steps 101 to 107.

In step 101, data messages received by the server are acquired by the device in a real-time manner, and each of the data messages received by the server within a preset time period is parsed to extract a feature from the data message.

The feature extracted from the data message may include a size (for example, 2 MB) of the data message, a source IP address of the data message, a destination IP address of the data message, a protocol type of the data message. The source IP address may be an IP address of a terminal which sends the data message to the server. The destination IP address may be an IP address of a target server to which the terminal sends the data message. The protocol type of the data message may be extracted from a flag bit of the data message.

In step 103, a ratio of the number of data messages in each protocol type to a total number of the data messages is obtained by the device based on the extracted feature.

In step 105, the device determines whether the ratio of the number of data messages in each protocol type to a total number of the data messages conforms to a ratio baseline (i.e., a ratio reference) corresponding to the protocol type.

The ratio baseline is a normal range of the ratio of the number of data messages in the protocol type to a total number of the data messages of the server within the preset time period.

In step 107, the device determines that the DDoS attack occurs in the server when the ratio of the number of data messages in each protocol type to a total number of the data messages does not conform to the ratio baseline corresponding to the protocol type.

For example, the DDoS attack which does not need too many data messages, such as, a connection flood, may be found by analyzing a change in a ratio of a synchronize (SYN) data message to the total number of the data messages. That is, the attack is found by determining whether the ratio of the SYN data message to the total number of the data messages conforms to the ratio baseline. SYN is a handshaking signal used when a TCP/IP connection is established. When a normal TCP network connection is established between a client device and a server, the client device sends a SYN message firstly, and the server responses a SYN+ACK message to indicate that the message is received. Then, the client device responses an ACK message. A reliable TCP connection is established between the client device and the server in this way, and then data is transmitted between the client device and the server.

In the method for detecting the Distributed Denial of Service attack provided by the embodiment, the ratio of the number of data messages in each protocol type to a total number of the data messages is obtained based on the feature extracted from each of the data messages. It is determined that the DDoS attack occurs in the server in the case that the ratio of the number of data messages in each protocol type to a total number of the data messages does not conform to the ratio baseline corresponding to the protocol type. In this way, the problems that the conventional detection method has a poor adaptability and a high misreport ratio are solved. With the method for detecting the DDoS attack based on the ratio information, the misreport is avoided by determining whether the ratio of the number of data messages in each protocol type to a total number of the data messages conforms to the ratio baseline corresponding to the protocol type, so that it is easy to find the DDoS attack. Therefore, according to the method and device according to the present disclosure, the occurrence of the DDoS attack can be rapidly, accurately, and timely detected, and it is able to adapt to various complex actual environments, for example, an environment in which the DDoS attack does not need too many data messages.

### Second Embodiment

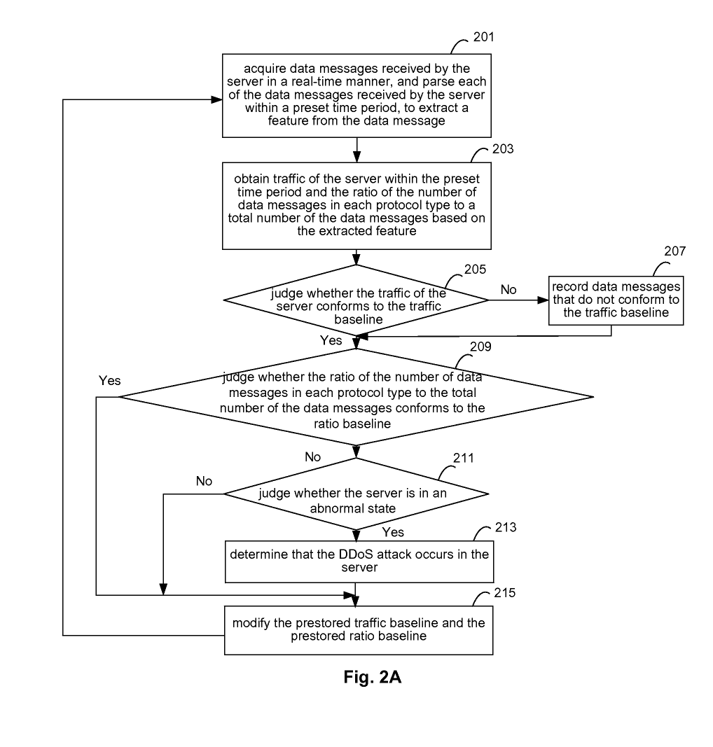

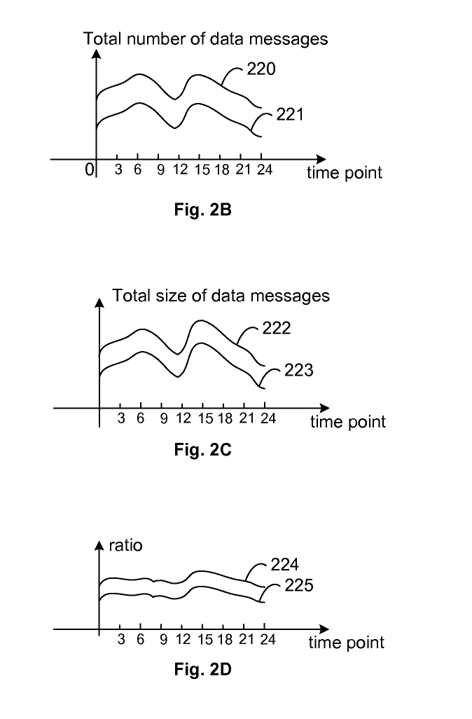

FIG. 2A is a flow diagram of a method for detecting a Distributed Denial of Service attack according to another embodiment of the present disclosure. FIG. 2A is obtained by modifying the embodiment as shown in FIG. 1. The method may be a process of detecting a Distributed Denial of Service attack, which is performed by a device for detecting the Distributed Denial of Service attack. The device for detecting the Distributed Denial of Service attack may run on some apparatus such as a detected server. Taking a case that the apparatus runs on the server as an example, the method for detecting the Distributed Denial of Service attack may include steps 201 to 215.

In step 201, data messages received by the server are acquired in a real-time manner, and each of the data messages received by the server within a preset time period is parsed to extract a feature from the data message.

Generally, the data message received by the server, as a device for providing service, is a message carried in a service request sent from a terminal to the server. One service request sent from the terminal may carry one or more data messages. The feature extracted from the data message includes a size (for example, 2 MB) of the data message, a source IP address of the data message, a destination IP address of the data message, a protocol type of the data message.

The source IP address may be an IP address of a terminal which sends the data message to the server. The destination IP address may be an IP address of a target server to which the terminal sends the data message. The protocol type of the data message may be extracted from a flag bit of the data message. The flag bit is configured to record the protocol type to which the data message belongs. The protocol type of the data message may be a certain protocol belonging to Open System Interconnect (OSI) model. The OSI model is made by the International Standardization Organization. In this OSI mode, network communication is divided into seven layers, i.e., a physical layer, a data link layer, a network layer, a transmission layer, a session layer, a presentation layer and an application layer. A protocol belonging to the network layer may include Internet Protocol (IP), Internetwork Packet Exchange (IPX) protocol, Open Shortest Path First (OSPF) protocol and so on. A protocol belonging to the transmission layer may include Transmission Control Protocol (TCP), User Datagram Protocol (UDP), Sequenced Packet Exchange (SPX) protocol and so on. A protocol belonging to the present disclosure layer may include the Telnet, File Transfer Protocol (FTP), Hypertext Transfer Protocol (HTTP), Simple Network Management Protocol (SNMP), Domain Name System (DNS) protocol and so on.

The preset time period may be set to a random value as required, for example, 10 minutes.

In step 203, traffic of the server within the preset time period and a ratio of the number of data messages in each protocol type to a total number of the data messages are obtained based on the feature extracted from each of the data messages, and the traffic of the server and the ratio of the number of data messages in each protocol type to a total number of the data messages are stored.

The traffic of the server includes but not limited to a total number and a total size of the data messages received by the server within the preset time period. The traffic of the server and the ratio of the number of data messages in each protocol type to a total number of the data messages may be stored in a database.

A method for calculating the ratio of the number of data messages in a protocol type to a total number of the data messages will be illustrated. For example, the number of data messages received by the server in the Http type within a time period is 80, a total number of the data messages received by the server is 100, and thus a ratio of the number of the data messages in the Http type to the total number of data messages is 80%.

In step 205, the obtained traffic of the server is matched with a pre-stored traffic baseline (i.e., a traffic reference) to determine whether the traffic of the server conforms to the traffic baseline, and step 209 is performed in a case that the traffic of the server conforms to the traffic baseline.

In an exemplary embodiment, the step 205 may further includes: performing step 207 in a case that the traffic of the server does not conform to the traffic baseline.

The baseline refers to a “snapshot” in a time period, which provides a standard for subsequent data. In an embodiment of the present disclosure, the baseline refers to a stable range of the traffic of the server within a time period, or a normal range of the ratio of the number of data messages in each protocol type to a total number of the data messages, which is a standard for determining whether the target server is normal.

The baseline may include a traffic baseline, a ratio baseline and so on. The traffic baseline is a normal range of the traffic of the server within the preset time period. The ratio baseline refers to a normal range of the ratio of the number of data messages in each protocol type, received by the server within the preset time period, to a total number of the data messages received by the server within the preset time period.

The baseline is pre-stored in a database, which may be trained and learned previously based on the acquired sample. The existing training and learning method may employ, for example, Bayesian method, Maximum Entropy method, and empirical method. The acquired sample may be data messages acquired within a time period. A method for training and learning the baseline based on the acquired sample may include: if the trained sample is data messages received by the server within one month, which is not attacked, obtaining a range (including maximum traffic and minimum traffic) of the traffic of server within each preset time period in the 24-hour period of a day is obtained by calculating a total number and a total size of data messages within each preset time period (for example, 10 minutes) in the one month. For example, between 12:10 p.m. and 12:20 p.m. on Monday, the calculated maximum total number of the data messages is 10,000, the minimum total number of the data messages is 9,000, the maximum total size of the data messages is 20 G, and the minimum total size of the data messages is 18 G. Then, between 12:10 p.m. and 12:20 p.m. on Monday, a range of the total number of the data messages is from 9,000 to 10,000. A range of the total size of the data messages is from 18 G to 20 G. The range of the traffic (including the range of the total number of data messages and the range of the total size of data messages) within each preset time period in a day is connected by a smooth curve, and then a graph of the maximum traffic and a graph of the minimum traffic in one day may be obtained. That is, a graph 220 of the maximum value the total number of data messages in the 24-hour period of a day and a graph 221 of the minimum value of the total number of data messages in the 24-hour period of a day are obtained, as shown in FIG. 2B; and a graph 222 of the maximum value of the total size of data messages in a day and a graph 223 of the minimum value of the total size of data messages in a day are obtained, as shown in FIG. 2C. A range between the graph of the maximum value and the graph of the minimum value in FIG. 2B and FIG. 2C is the traffic baseline. A normal range of the traffic should be in the range of the traffic baseline. Abscissa axes in FIG. 2B and FIG. 2C refer to different time points in the 24-hour period of a day. Similarly, within each preset time period (for example, 10 minutes) in one month, a ratio of the number of data messages in each protocol type to a total number data messages may be calculated based on the method described above, to obtain a range of the ratio of the number of data messages in each protocol type to a total number of data messages, within each preset time period in the 24-hour period of a day. The range of the ratio in each preset time period in a day is connected by a smooth curve, to obtain a graph of the maximum ratio value and a graph of the minimum ratio value in a day. A range between the graph of the maximum ratio value and the graph of the minimum ratio value is the ratio baseline. A normal ratio range should be in a range of the ratio baseline. A graph 224 of the maximum value of the ratio of the number of data messages in one protocol type to a total number of data messages in a day and a graph 225 of the minimum value of the ratio of the number of data messages in a protocol type to a total number of data messages in a day are shown in FIG. 2D. A range between the graph 224 of the maximum value and a graph 225 of the minimum value is the ratio baseline. An abscissa axis in FIG. 2D refers to different time points in the 24-hour period of a day.

In an exemplary embodiment, in the step 205, the process of determining whether the traffic of the server conforms to the traffic baseline may include: determining that the traffic of the server conforms to the traffic baseline (e.g., within the maximum and minimum values of the traffic baseline) when the traffic of the server is in a normal range of traffic within a preset time period; and determining that the traffic of the server does not conform to the traffic baseline (e.g., outside the maximum and minimum values of the traffic baseline) when the traffic of the server is not in a normal range of traffic within a preset time period.

In step 207, data messages which do not conform to the traffic baseline are recorded, and step 209 is performed.

In step 209, it is determined whether the ratio of the number of data messages in each protocol type to a total number of the data messages conforms to the ratio baseline (e.g., within the maximum and minimum values of the ratio baseline) corresponding to the protocol type, and step 211 is performed in the case that the ratio of the number of data messages in each protocol type to the total number of the data messages does not conform to the ratio baseline corresponding to the protocol type (e.g., outside the maximum and minimum values of the traffic baseline).

In an exemplary embodiment, the step 209 may further includes: performing step 215 when the ratio of the number of data messages in each protocol type to the total number of the data messages conforms to the ratio baseline corresponding to the protocol type.

The method for acquiring the ratio baseline is illustrated in detail in the step 205, which will be omitted herein.

In an exemplary embodiment, in the step 209, the process of determining whether the ratio of the number of data messages in each protocol type to the total number of the data messages conforms to the ratio baseline corresponding to the protocol type may include: determining that the ratio of the number of data messages in each protocol type to the total number of the data messages conforms to the ratio baseline corresponding to the protocol type when the ratio of the number of data messages in the protocol type to the total number of data messages is in a normal ratio range; and determining that the ratio of the number of data messages in each protocol type to the total number of the data messages does not conform to the ratio baseline corresponding to the protocol type when the ratio of the number of data messages in the protocol type to the total number of data messages is not in a normal ratio range,

In step 211, data messages which do not conform to the ratio baseline are recorded, whether a state of the server is an abnormal state is determined, and step 213 is performed in the case that the state of the server is an abnormal state.

For example, a DDoS attack which does not need too many data messages, such as, connection flood, may be found by analyzing a change in a ratio of a synchronize (SYN) data message to the total number of the data messages. That is, the attack is found by determining whether the ratio of the SYN data message to the total number of the data messages conforms to the ratio baseline. SYN is a handshaking signal used when a TCP/IP connection is established. When a normal TCP network connection is established between a client device and a server, the client device sends a SYN message firstly, and the server responses a SYN+ACK message to indicate that the message is received. Then, the client device responses an ACK message. A reliable TCP connection is established between the client device and the server in this way, and then data is transmitted between the client device and the server.

In an exemplary embodiment, after the step 211, the method further includes: performing step 215 when the state of the server is not an abnormal state.

The state of the server may include, for example, CPU usage of the server, memory usage of the server and so on.

Whether the state of the server is an abnormal state may be determined by: acquiring CPU usage of the server and memory usage of the server; determining whether at least one of a condition (i) and a condition (ii) is satisfied, where the condition (i) is that the CPU usage of the server is greater than a first preset value, and condition (ii) is that the memory usage of the server is greater than a second preset value; determining that the state of the server is an abnormal state when at least one of the condition (i) and the condition (ii) is satisfied, and determining that the state of the server is not an abnormal state when both condition (i) and condition (ii) are not satisfied.

In the embodiment of the present disclosure, whether the state of the server is the abnormal state may also be determined by determining whether any other resource of the server is greater than a certain threshold.

In step 213, it is determined that the DDoS attack occurs in the server.

In step 215, the pre-stored traffic baseline and the pre-stored ratio baseline are modified based on the obtained traffic of the server within the preset time period and the ratio of the number of data messages in each protocol type to a total number of the data messages, and the step 201 is then performed.

The traffic baseline and the ratio baseline may be trained and learned based on the obtained server traffic and the ratio of data messages in each protocol type to a total number of the data messages respectively, to modify the pre-stored traffic baseline and the pre-stored ratio baseline. The training and learning method may be various methods described in step 205, which will be omitted herein.

In the method for detecting the Distributed Denial of Service attack provided by the embodiment, whether the state of the server is an abnormal state is further determined, it is determined that the DDoS attack occurs in the server in the case that the state of the server is an abnormal state. In this way, the DDoS attack may be detected accurately, and whether the traffic conforms to the traffic baseline may also be determined. In addition, the pre-stored traffic baseline and the pre-stored ratio baseline are also modified based on the obtained traffic of the server within the preset time period and the ratio of the number of data messages in each protocol type to the total number of the data messages. Therefore, the baseline data may be modified in a real-time manner by utilizing detection data under no attack, which can make the baseline more in conformity with an actual environment, and ensure a detection result more accurate.

### Third Embodiment

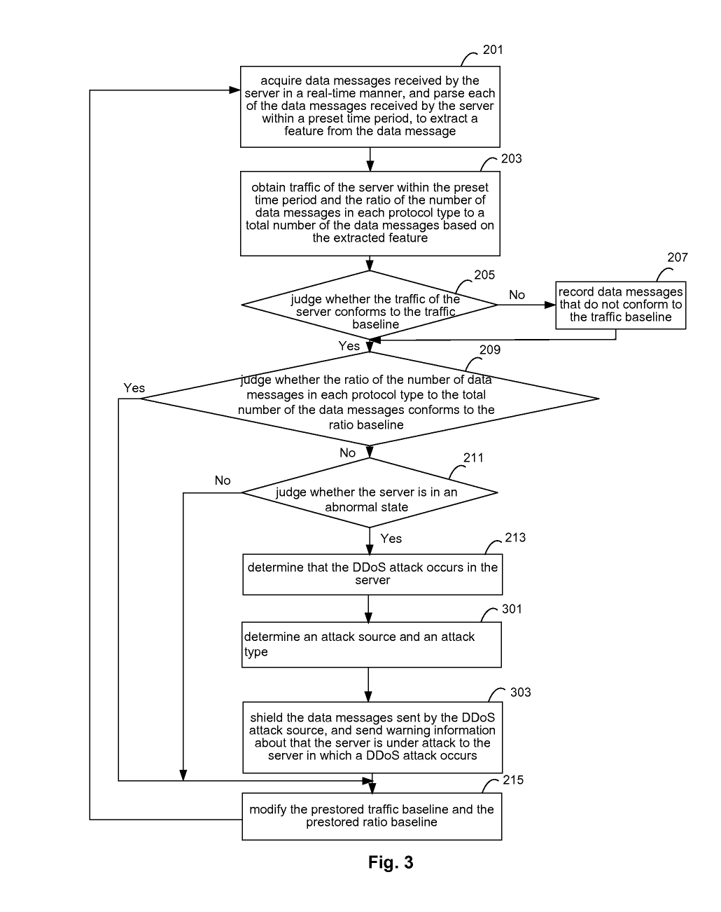

Referring to FIG. 3, a flow diagram of a method for detecting a Distributed Denial of Service attack is shown according to yet other embodiment of the present disclosure. The method may be a process of detecting a Distributed Denial of Service attack, which is performed by a device for detecting a DDoS attack. The device for detecting the Distributed Denial of Service attack may run on some apparatus such as a detected server. Taking a case that the device runs on the server as an example, the method for detecting the Distributed Denial of Service attack in the embodiment is similar to the method for detecting the Distributed Denial of Service attack as shown in FIG. 2, and a difference therebetween is that the method in the embodiment further includes step 301 and step 303.

In an exemplary embodiment, after step 213, the method may further include step 301.

In step 301, a DDoS attack source which sends the data messages that do not conform to the ratio baseline is determined; it is determined that an attack type is an attack in which a bandwidth of the server for receiving data is consumed when the traffic of the server does not conform to the traffic baseline; and it is determined that an attack type is an attack in which server resources is consumed when the traffic of the server conforms to the traffic baseline.

The resource of the server includes resources such as a CPU resource of the server, a memory resource of the server.

In step 303, the data messages sent from the DDoS attack source are shielded, and warning information about that the server is under attack is sent to the server in which a DDoS attack occurs.

When it is determined that the DDoS attack occurs in the server, a warning information such as “the server suffers a DDoS attack, and the attack is an attack in which server resources is consumed” is sent to the server in which the DDoS attack occurs. After the DDoS attack source is determined, data messages which is sent from the DDoS attack source and dose not conform to the traffic baseline, and data messages which is sent from the DDoS attack source and does not conform to the ratio baseline are shielded, that is, such data messages are not received.

In the method for detecting the Distributed Denial of Service attack provided by the embodiment, the DDoS attack source for sending the data messages which do not conform to the ratio baseline is determined, the attack type is determined by the traffic of the server, the data messages sent from the DDoS attack source are shielded, and the warning information about that the server is under attack is sent to the server in which the DDoS attack occurs. In this way, the occurred DDoS attack may be blocked rapidly and timely, and the attack type may be determined, and the server may be rapidly warned and notified.

A device according to an embodiment of the present disclosure is illustrated below, and details which are not described in the device according to the embodiment may refer to the method according to the above embodiment.

### Fourth Embodiment

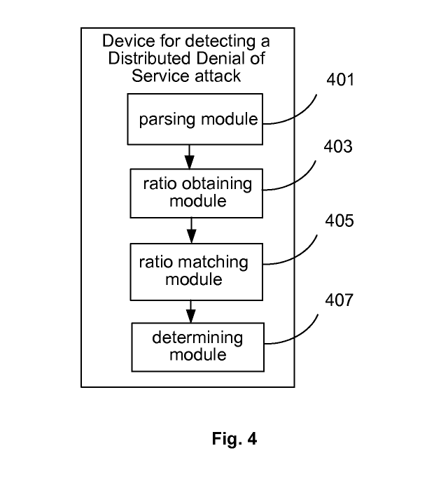

Referring to FIG. 4, a block diagram of a main architecture of a device for detecting a Distributed Denial of Service attack is shown according to an embodiment of the present disclosure. The device for detecting the Distributed Denial of Service attack includes a parsing module 401, a ratio obtaining module 403, a ratio matching module 405 and a determining module 407.

Specifically, the parsing module 401 is configured to acquire data messages received by a server in a real-time manner, and parse each of the data messages received by the server within a preset time period, to extract a feature from the data message.

The feature extracted from each of the data message may include a size of a data message, a source IP address of the data message, a destination IP address of the data message, a protocol type of the data message and so on.

The ratio obtaining module 403 is configured to obtain a ratio of the number of data messages in each protocol type to a total number of the data messages based on the extracted feature.

The ratio matching module 405 is configured to determine whether the ratio of the number of data messages in each protocol type to a total number of the data messages conforms to the ratio baseline corresponding to the protocol type.

Specifically, the ratio baseline is a normal range of the ratio of the number of data messages in the protocol type to a total number of the data messages of the server within the preset time period.

The determining module 407 is configured to determine that a DDoS attack occurs in the server when the ratio of the number of data messages in each protocol type to a total number of the data messages does not conform to the ratio baseline corresponding to the protocol type.

In the device for detecting the Distributed Denial of Service attack provided by the embodiment, the ratio of the number of data messages in each protocol type to a total number of the data messages is obtained based on the feature extracted from each of the data messages. It is determined that the DDoS attack occurs in the server in the case that the ratio of the number of data messages in each protocol type to a total number of the data messages does not conform to the ratio baseline corresponding to the protocol type. In this way, the problems that the conventional detection method has a poor adaptability and a high misreport ratio are solved. With the method for detecting the DDoS attack based on the ratio information, the misreport is avoided by determining whether the ratio of the number of data messages in each protocol type to a total number of the data messages conforms to the ratio baseline corresponding to the protocol type, so that it is easy to find the DDoS attack. Therefore, according to the method and device according to the present disclosure, the occurrence of the DDoS attack can be rapidly, accurately, and timely detected, and it is able to adapt to various complex actual environments, for example, an environment in which the DDoS attack does not need too many data messages.

### Fifth Embodiment

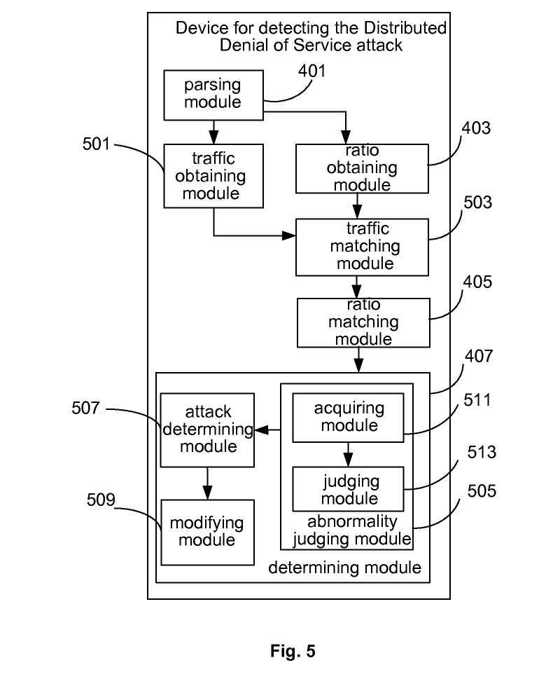

Referring to FIG. 5, a block diagram of a main architecture of a device for detecting a Distributed Denial of Service attack is shown according to another embodiment of the present disclosure. The device in the embodiment is similar to the device for detecting the Distributed Denial of Service attack as shown in FIG. 4, and a difference therebetween is that the apparatus in the embodiment may further include a traffic obtaining module 501 and a traffic matching module 503. The determining module 407 may include an abnormality determining module 505, an attack determining module 507 and a modifying module 509. The abnormality determining module 505 may further include an acquiring module 511 and a determining module 513.

The traffic obtaining module 501 is configured to obtain traffic of the server within the preset time period based on the extracted feature.

The traffic of the server includes but not limited to a total number and a total size of the data messages received by the server within the preset time period.

The traffic matching module 503 is configured to determine whether the traffic of server conforms to the traffic baseline. The traffic baseline may be a normal range of the traffic of the server within the preset time period.

In an exemplary embodiment, the ratio matching module 405 is further configured to determine that the traffic of the server conforms to the traffic baseline when the traffic of the server is in the normal range of the traffic within the preset time period; and determine that the traffic of the server does not conform to the traffic baseline when the traffic of the server is not in the normal range of the traffic within the preset time period.

In an exemplary embodiment, the traffic matching module 503 is further configured to determine that the ratio of the number of data messages in each protocol type to the total number of the data messages conforms to the ratio baseline corresponding to the protocol type when the ratio of the number of data messages in each protocol type to a total number of the data messages is in the normal ratio range; and determine that the ratio of the number of data messages in each protocol type to the total number of the data messages does not conform to the ratio baseline corresponding to the protocol type when the ratio of the number of data messages in each protocol type to a total number of the data messages is not in the normal ratio range.

The abnormality determining module 505 is configured to determine whether a state of the server is an abnormal state.

The attack determining module 507 is configured to determine that the DDoS attack occurs in the server when the state of the server is an abnormal state.

The modifying module 509 is configured to modify the pre-stored traffic baseline and the pre-stored ratio baseline based on the obtained traffic of the server within the preset time period and the ratio of the number of data messages in each protocol type to a total number of the data messages when the state of the server is not an abnormal state.

In an exemplary embodiment, the abnormality determining module 505 may further include the acquiring module 511 and the determining module 513.

The acquiring module 511 is configured to acquire CPU usage of the server and memory usage of the server.

The determining module 513 is configured to determine whether at least one of condition (i) and condition (ii) is satisfied, where the condition (i) is that the CPU usage of the server is greater than a preset value, and the condition (ii) is that the memory usage of the server is greater than a second preset value, and determine that the state of the server is an abnormal state in the case that at least one of the condition (i) and the condition (ii) is satisfied, and determine that the state of the server is not an abnormal state in the case that any one of the condition (i) and the condition (ii) is not satisfied.

In the device for detecting the Distributed Denial of Service attack provided by the embodiment, whether the state of the server is an abnormal state is further determined, it is determined that the DDoS attack occurs in the server in the case that the state of the server is an abnormal state. In this way, the DDoS attack may be detected accurately, and whether the traffic conforms to the traffic baseline may also be determined. In addition, the pre-stored traffic baseline and the pre-stored ratio baseline are also modified based on the obtained traffic of the server within the preset time period and the ratio of the number of data messages in each protocol type to the total number of the data messages. Therefore, the baseline data may be modified in a real-time manner by utilizing detection data under no attack, which can make the baseline more in conformity with an actual environment, and ensure a detection result more accurate.

### Sixth Embodiment

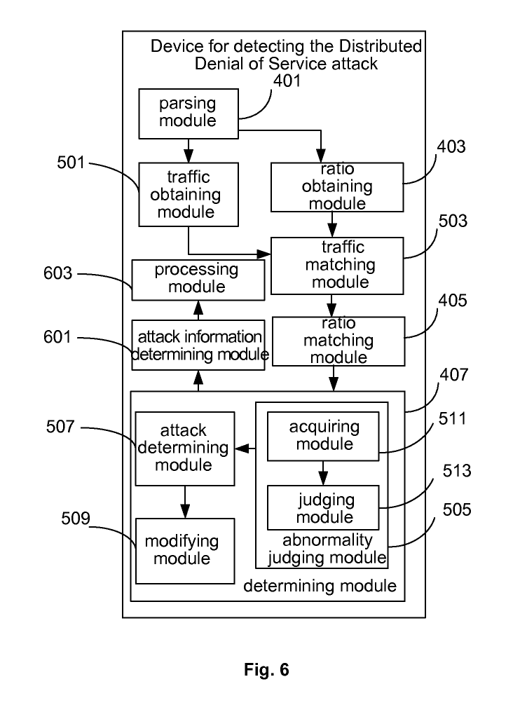

Referring to FIG. 6, a block diagram of a main architecture of a device for detecting a Distributed Denial of Service attack is shown according to yet other embodiment of the present disclosure. The device in the embodiment is similar to the device for detecting the Distributed Denial of Service attack as shown in FIG. 5, and a difference therebetween is that the device in the embodiment may further include an attack information determining module 601 and a processing module 603.

The attack information determining module 601 is configured to determine a DDoS attack source which sends the data messages that do not conform to the ratio baseline, and determine that an attack type is an attack in which a bandwidth of the server for receiving data is consumed when the traffic of the server does not conform to the traffic baseline; and determine that an attack type is an attack in which server resources are consumed when the traffic of the server conforms to the traffic baseline.

The warning module 603 is configured to shield the data messages sent from the DDoS attack source, and send warning information about that the server is under attack to the server in which the DDoS attack occurs

In the device for detecting the Distributed Denial of Service attack provided by the embodiment, the DDoS attack source for sending the data messages which do not conform to the ratio baseline is determined, the attack type is determined by the traffic of the server, the data messages sent from the DDoS attack source are shielded, and the warning information about that the server is under attack is sent to the server in which the DDoS attack occurs. In this way, the occurred DDoS attack may be blocked rapidly and timely, and the attack type may be determined, and the server may be rapidly warned and notified.

### Seventh Embodiment

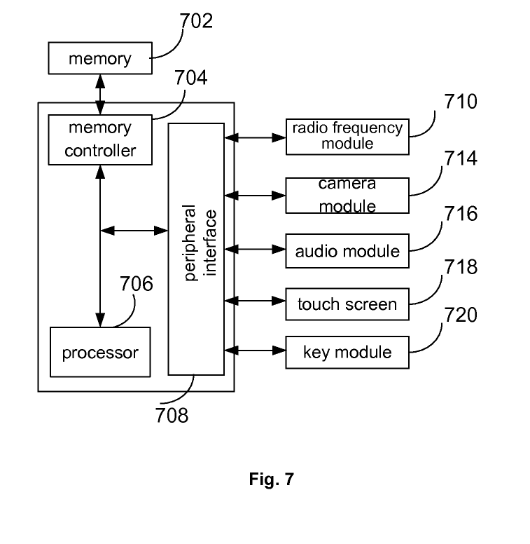

FIG. 7 is a block diagram of a structure of a terminal. As shown in FIG. 7, taking a case that the device for detecting the Distributed Denial of Service attack runs on the terminal as an example, the terminal includes a memory 702, a memory controller 704, one or more processors 706 (only one processor is shown in FIG. 7), a peripheral interface 708, a radio frequency module 710, a camera module 714, an audio module 716, a touch screen 718 and a key module 720, which are communicated with each other by one or more communication buses or signal lines

It may be understood that the structure shown in FIG. 7 is only schematic, the terminal may further include more or less components than those in FIG. 7, or may have a different configuration from that shown in FIG. 7. Each of the components shown in FIG. 7 may be realized by hardware, software or a combination thereof.

The memory 702 may be used to store a software program or module, such as a program instruction/module corresponds to the method for detecting the Distributed Denial of Service attack in the embodiments of the present disclosure, where the method is performed in the terminal. For example, the program instruction/module may include the parsing module 401, the ratio obtaining module 403, the ratio matching module 405, the determining module 407, and the traffic obtaining module 501, the traffic matching module 503, the attack information determining module 601 and the processing module 603 in the device for detecting the Distributed Denial of Service attack. The processor 702 performs various functional applications and data processing by running the software program and module stored in the memory 704. The method for detecting the Distributed Denial of Service attack described above can be performed in the terminal.

The memory 702 may include a high speed random memory, and may further include a non-volatile memory, such as one or more magnetic storage devices and flash memories, or other volatile solid state memory. In some embodiments, the memory 702 may further include a memory remotely provided to the processor 706, and the remotely provided memory may be connected to the terminal via a network. The network described above includes but not limited to an internet, an intranet, a Local Area Network, a mobile communication network and any combinations thereof. The processor 706 and other possible components may access the memory 702 under control of the memory controller 704.

The peripheral interface 708 couples various input/output devices to CPU and the memory 702. The processor 706 runs a variety of software and instructions in the memory 702 to perform various functions of the terminal and data processing.

In some embodiments, the peripheral interface 708, the processor 706 and the memory controller 704 may be realized in a single chip. In other embodiments, the peripheral interface 708, the processor 706 and the memory controller 704 may be realized in individual chips, respectively.

The radio frequency module 710 is used to receive and send an electromagnetic wave to convert an electromagnetic wave to an electrical signal, and therefore the radio frequency module 710 may communicate with a communication network or other devices. The radio frequency module 710 may include various existing circuit elements for implementing the function of the radio frequency module, such as an antenna, a radio frequency transceiver, a digital signal processor, an encryption/decryption chip, a Subscriber Identity Module (SIM) card, a memory. The ratio frequency module 710 may communication with various networks such as a network, an intranet, a wireless network, or may communication with other devices via a wireless network. The wireless network described above may include a cellular telephone network, a Wireless LAN or a Metropolitan Area Network. The wireless network described above may use various communication standards, protocols and techniques, including but not limited to a Global System for Mobile communication (GSM), an Enhanced Data GSM Environment (EDGE), a Wideband Code Division Multiple Access (W-CDMA), a Code Division Multiple Access (CDMA), a Time Division Multiple Access (TDMA), a Bluetooth, a Wireless Fidelity (WiFi) (such as American Institute of Electrical and Electronic Engineers IEEE 802.11a, IEEE 802.11b, IEEE 802.11g, and/or IEEE 802.11n), a Voice over Internet Protocol (Vol P), a Worldwide Interoperability for Microwave Access (Wi-Max), other protocols for a mail, an instant messaging, and a short message, and any other suitable communication protocols, and even including those protocols which are not developed yet.

The camera module 714 is used to capture a phone or a video. The captured phone or video may be stored in the memory 702, and may be sent through the radio frequency 710.

The audio module 716 provides an audio interface to the user, which may include one or more microphones, one or more loudspeakers and an audio circuit. The audio circuit receives voice data from the peripheral interface 708, converts the voice data into electrical information, and outputs the electrical information to the loudspeaker. The loudspeaker converts the electrical information into a sound wave which can be heard by a human ear. The audio circuit also receives electrical information from the microphone, converts the electrical information into voice data, and transmits the voice data to the peripheral interface 708 to further process. Audio data may be acquired from the memory 702 or be acquired through the radio frequency module 710. Furthermore, the audio data may be stored in the memory 702 or be sent through the radio frequency module 710. In some embodiments, the audio module 716 may further include a headphone jack used to provide the audio interface to a headphone or other devices.

The touch screen 718 provides an output and input interface between the terminal and the user. Specifically, the touch screen 718 displays a video output to the user, and content of the video output may include a text, a graphics, a video and any combination thereof. Some output results correspond to some user interface objects. The touch screen 718 further receives a user input, for example, a gesture operation of the user such as a click operation or a slide operation, to make the user interface object response to the user input. A technology for detecting the user input may be based on resistive one, a capacitive one or other any possible touch detection technology. An example of a display unit of the touch screen 718 includes but not limited to a liquid crystal display or a light-emitting polymer display.

The keypad module 720 also provides an input interface of the terminal to the user. The user may press different keys, and the terminal then performs different functions.

Furthermore, the embodiments of the present disclosure further provide a computer-readable memory medium in which computer-executable instructions are stored. The computer-readable memory medium described above is, for example, a non-volatile memory, such as an optical disk, a hard disk or a flash memory. The computer-executable instructions described above are used to make a computer or a similar operating apparatus implement the method for detecting the Distributed Denial of Service attack described above.

The foregoing are only preferred embodiments of the present disclosure and therefore are not intended to limit the present disclosure. Although the present disclosure is disclosed above in the preferred embodiments, the preferred embodiments are not intended to limit the present disclosure, some changes or modifications made by those skilled in the art by utilizing the technical content disclosed above without departing from the scope of the technical solution of the present disclosure belong to an equivalent embodiment having an equivalent changes, and any simple changes, equivalent alternates and modifications made to the embodiments above according to the technical essence of the present disclosure without departing from content of the technical solution of the present disclosure will fall in the scope of the technical solution of the present disclosure.

1. A method for detecting a Distributed Denial of Service attack, the method comprising:
real-time acquiring, by an electronic device, a plurality of data messages received by a server within a preset time period;
for each of the plurality of data messages, parsing, by the electronic device, the data message to extract a feature, wherein
the feature includes a protocol type of a plurality of protocol types, and
each of the plurality of protocol types is associated with a number of data messages in the plurality of data messages;
for each of the plurality of prototypes,
obtaining a ratio between the number of data messages associated with the protocol type and a total number of the plurality of the data messages based on the extracted feature;
determining whether the ratio conforms to a preset ratio baseline corresponding to the protocol type; and
when the ratio does not conform to the preset ratio baseline determining that the Distributed Denial of Service attack occurs in the server and informing the server about the Distributed Denial of Service attack.

2. The method according to claim 1, wherein for each of the plurality of protocol types, the preset ratio baseline is a normal range of a ratio between a normal number of data messages associated with the protocol type that should have been received by the server with the preset time period and a normal total number of data messages that should have been received by the server within the preset time period.

3. The method according to claim 1, further comprising:
obtaining, by the electronic device, traffic of the server within the preset time period based on the extracted feature;
matching the obtained traffic of the server with a pre-stored traffic baseline; and
determining whether the traffic of the server conforms to the pre-stored traffic baseline,
wherein the traffic of the server comprises the total number of the plurality of data messages received by the server within the preset time period and a total size of the plurality of data messages, and the pre-stored traffic baseline is a normal range of the traffic of the server within the preset time period.

4. The method according to claim 3, wherein the determining of whether the traffic of server conforms to the pre-stored traffic baseline comprises:
determining that the traffic of the server conforms to the pre-stored traffic baseline when the traffic of the server is within the normal range of the traffic within the preset time period; and
determining that the traffic of server does not conform to the traffic baseline when the traffic of the server is outside of the normal range of the traffic within the preset time period.

5. The method according to claim 2, wherein the determining of whether the ratio conforms to the preset ratio baseline corresponding to the protocol type comprises:
determining that the ratio conforms to the preset ratio baseline when the ratio is in the normal range of the ratio corresponding to the protocol type; and
determining that the ratio does not conform to the preset ratio baseline when the ratio of the number of data messages in each protocol type to the total number of the data messages is outside of the normal range of the ratio corresponding to the protocol type.

6. The method according to claim 3, wherein the determining of the occurrence of the Distributed Denial of Service attack comprises:
determining whether the server is in an abnormal state;
determining that the Distributed Denial of Service attack occurs in the server when the server is in the abnormal state; and
modifying the pre-stored traffic baseline and the preset ratio baseline based on the obtained traffic of the server within the preset time period and the ratio associated with each of the plurality of protocol type when the server is not in the abnormal state.

7. The method according to claim 6, wherein the determining of whether the server is in an abnormal state comprises:
acquiring CPU usage of the server and memory usage of the server;
determining whether the CPU usage of the server is greater than a preset value, and whether the memory usage of the server is greater than a second preset value;
determining that the server is in the abnormal state when the CPU usage of the server is greater than a preset value or when the memory usage of the server is greater than a second preset value; and
determining that the server is not in the abnormal state when the CPU usage of the server is less than a preset value and that the memory usage of the server is not greater than a second preset value.

8. The method according to claim 3, further comprising:
determining a Distributed Denial of Service attack source which sends data messages to the server that do not conform to the ratio baseline;
determining that the Distributed Denial of Service attack is an attack in which a bandwidth of the server for receiving data is consumed when the traffic of the server does not conform to the traffic baseline;
determining that the Distributed Denial of Service attack is an attack in which server resources are consumed when the traffic of the server conforms to the traffic baseline; and
shielding the data messages sent from the DDoS attack source, and sending warning information about that the server is under attack to the server.

9. The method according to claim 1, wherein the extracted feature further comprises at least one of a size of the data message, a source IP address of the data message, and a destination IP address of the data message.

10. A device, comprising:
a storage medium including a set of instructions for detecting a Distributed Denial of Service attack;
a processor in communication with the storage medium, wherein when executing the set of instructions, the processor is directed to:
real-time acquire a plurality of data messages received by a server within a preset time period; and
for each of the plurality of data messages, parse the data message to extract a feature, wherein
the feature includes a protocol type of a plurality of protocol types, and
each of the plurality of protocol types is associated with a number of data messages in the plurality of data messages;
for each of the plurality of prototypes,
obtain a ratio between the number of data messages associated with the protocol type and a total number of the plurality of the data messages based on the extracted feature;
determine whether the ratio conforms to a preset ratio baseline corresponding to the protocol type; and
when the ratio does not conform to the preset ratio baseline determine that the Distributed Denial of Service attack occurs in the server and informing the server about the Distributed Denial of Service attack.

11. The device according to claim 10, wherein for each of the plurality of protocol types, the preset ratio baseline is a normal range of a ratio between a normal number of data messages associated with the protocol type that should have been received by the server with the preset time period and a normal total number of data messages that should have been received by the server within the preset time period.

12. The device according to claim 10, wherein the processor is further directed to:
obtain traffic of the server within the preset time period based on the extracted feature;
match the obtained traffic of the server with a pre-stored traffic baseline; and
determine whether the traffic of the server conforms to the pre-stored traffic baseline,
wherein the traffic of the server comprises the total number of the data messages received by the server within the preset time period and a total size of the plurality of data messages, and the pre-stored traffic baseline is a normal range of the traffic of the server within the preset time period.

13. The device according to claim 12, wherein the traffic matching module is further configured to determine that the traffic of server conforms to the traffic baseline when the traffic of the server is in the normal range of the traffic within the preset time period; and determine that the traffic of server does not conform to the traffic baseline when the traffic of the server is not in the normal range of the traffic within the preset time period.

14. The device according to claim 11, wherein to determine the ratio conforms to the preset ratio baseline corresponding to the protocol the processor is further directed to:
determine that the ratio conforms to the preset ratio baseline when the ratio is in the normal range of the ratio corresponding to the protocol type; and
determine that the ratio does not conform to the ratio baseline when the ratio of the number of data messages in each protocol type to the total number of the data messages is outside of the normal range of the ratio corresponding to the protocol type.

15. The device according to claim 12, wherein to determine the occurrence of the Distributed Denial of Service attack the processor is further directed to:
determine whether the server is in an abnormal state;
determine that the Distributed Denial of Service attack occurs in the server when the server is in the abnormal state; and
modify the pre-stored traffic baseline and the preset ratio baseline based on the obtained traffic of the server within the preset time period and the ratio associated with each of the plurality of protocol type when the server is not in the abnormal state.

16. The device according to claim 15, wherein to determine whether the server is in an abnormal state the processor is further directed to:
acquire CPU usage of the server and memory usage of the server;
determine whether the CPU usage of the server is greater than a preset value, and whether the memory usage of the server is greater than a second preset value;
determine that the server is in the abnormal state when the CPU usage of the server is greater than a preset value, or when the memory usage of the server is greater than a second preset value; and
determine that the server is not in the abnormal state when the CPU usage of the server is less than a preset value and that the memory usage of the server is not greater than a second preset value.

17. The device according to claim 12, wherein the processor is further directed to:
determine a Distributed Denial of Service attack source which sends data messages to the server that do not conform to the ratio baseline;
determine that the Distributed Denial of Service attack is an attack in which a bandwidth of the server for receiving data is consumed when the traffic of the server does not conform to the traffic baseline;
determining that the Distributed Denial of Service attack is an attack in which server resources are consumed when the traffic of the server conforms to the traffic baseline; and
shield the data messages sent from the DDoS attack source, and send warning information about that the server is under attack to the server.

18. The device according to claim 10, wherein the extracted feature further comprises at least one of a size of the data message, a source IP address of the data message, and a destination IP address of the data message.

19. A non-transitory computer-readable storage medium comprising a set of instructions for detecting a Distributed Denial of Service attack, wherein the set of instructions, when executed by a computer, directs the computer to perform operations of:
real-time acquiring data messages received by a server within a preset time period;
for each of the plurality of data messages, parsing the data message to extract a feature, wherein
the feature includes a protocol type of a plurality of protocol types, and
each of the plurality of protocol types is associated with a number of data messages in the plurality of data messages;
for each of the plurality of prototypes,
obtaining a ratio between the number of data messages associated with the protocol type and a total number of the plurality of data messages based on the extracted feature;
determining whether the ratio conforms to a preset ratio baseline corresponding to the protocol type; and
when the ratio does not conform to the preset ratio baseline determining that the Distributed Denial of Service attack occurs in the server and informing the server about the Distributed Denial of Service attack.

20. The storage medium according to the claim 19, wherein for each of the plurality of protocol types, the preset ratio baseline is a normal range of a ratio between a number of data messages associated with in the protocol type that should have been received by the server with the preset time period and a normal total number of data messages that should have been received by the server within the preset time period.
